(19) United States
(12) Patent Application Publication
(10) Pub. No.: US 2020/0383862 A1
(43) Pub. Date: Dec. 10, 2020

(54) CINERARY URN SET

(71) Applicant: ARUMDAUN DONG SAN CO., LTD, Seoul (KR)

(72) Inventor: Taek Ki MIN, Seoul (KR)

(21) Appl. No.: 16/960,813

(22) PCT Filed: Dec. 29, 2018
(86) PCT No.: PCT/KR2018/016718

§ 371 Date: Jul. 8, 2020

(30) Foreign Application Priority Data
Jan. 10, 2018 (KR) 10-2018-0003248

(51) Int. Cl. A61G 17/08

(52) U.S. Cl. CPC A61G 17/08

(57) ABSTRACT

A cinerary urn set includes: a main chamber having a space for storing ashes; a check valve part coupled to the main chamber to open and close the main chamber; and a control chamber coupled to the check valve part and communicating with the main chamber. Accordingly, it is possible to continuously store the contents in the cinerary urn.

### TECHNICAL FIELD

The present invention relates to a cinerary urn set, and more particularly to a cinerary urn set capable of continuously storing the contents in a cinerary urn.

### BACKGROUND ART

To date, burial-type funeral have been preferred in Korea. However, cremation-type funeral have recently become popular due to the reduced land area occupied by cemeteries and easy management thereof.

In a cremation-type funeral, the bones of a dead body are incinerated and stored in a cinerary urn.

As disclosed in Korean Utility Model Registration No. 20-0418664, titled “cinerary urn”, a cinerary urn is composed of a body 2 having a space for storing ashes and a cover 1 for closing the body 2. In this case, because the ashes in the cinerary urn may decay or decompose when moisture or the like is introduced into the cinerary urn, there is a need for a cinerary urn capable of completely isolating the inside thereof from the outside thereof.

In Korean Utility Model Registration No. 20-0459499, titled “cinerary urn assembly”, which is illustrated in FIG. 5, a packing 21 is interposed between a body 10 and a cover 20A so as to hermetically close the inside of a cinerary urn. An injection port 26A is formed in the cover 20a, and antiseptic gas is charged into the space in the closed cinerary urn, thereby preventing the ashes in the cinerary urn from decomposing. However, because the operation of charging the antiseptic gas into the cinerary urn must be performed by a skilled person or using an expensive device, it is difficult to individually charge antiseptic gas into cinerary urns. Furthermore, when an external temperature of a cinerary urn varies with the change in seasons, dew condensation may occur in the cinerary urn due to the difference between the external temperature and the internal temperature of the cinerary urn. In this case, it is difficult to prevent the dew condensation using only the antiseptic gas charged in the cinerary urn.

In Korean Patent Registration No. 10-1060706, titled “cinerary urn capable of preventing generation of moisture and unpleasant odor”, which is illustrated in FIG. 6, a first box 20, which receives ashes, is provided therearound with a charcoal layer 30 such that the charcoal in the charcoal layer 30 absorbs moisture and unpleasant odors. However, because there is a limit to the ability of the charcoal to remove moisture, the charcoal is not able to fulfill its original function normally, and thus the ashes in the cinerary urn may decompose after the ashes are stored for a long time.

The present applicant has previously filed a patent application, titled “cinerary urn” with Korean Patent Office, and Korean Patent Registration No. 10-0439762 had been granted in connection therewith. As illustrated in FIG. 7, the cinerary urn is constructed such that a pressure gauge 5 is connected to a capsule for storing ashes so as to check the internal pressure in the capsule 2. However, the pressure gauge of the cinerary urn is capable only of allowing the internal pressure in the capsule to be checked but is incapable of preventing the internal pressure in the capsule from becoming equal to the pressure outside the capsule over time. Hence, because it is impossible to prevent dew condensation in the capsule, there is a need to provide an additional means for preventing dew condensation in the capsule, which is cumbersome.

Furthermore, in order to prevent old books, cultural goods or the like from being damaged or decomposed due to moisture during storage thereof, there is a need to control humidity in the storage space.

### DISCLOSURE

### Technical Problem

Therefore, the present invention has been made in view of the above problems, and it is an object of the present invention to provide a cinerary urn set capable of continuously preventing generation of moisture or the like in the cinerary urn.

Furthermore, another object of the present invention is to provide a cinerary urn set enabling easy maintenance and control of the cinerary urn even when the cinerary urn is separately stored.

### Technical Solution

In accordance with an aspect of the present invention, the above and other objects can be accomplished by the provision of a cinerary urn set including a main chamber having a space for storing ashes therein, a check valve unit including a first check valve, which is detachably coupled to or integrally formed with the main chamber, and a second check valve, which is detachably coupled to the first check valve and which is configured to communicate with the first check valve when the second check valve is coupled to the first check valve, and a control chamber, which is detachably coupled to or integrally formed with the second check valve and which is configured to communicate with the main chamber when the control chamber is coupled to the second check valve, wherein the first check valve includes a first cylindrical portion coupled to the main chamber, a first support protrusion, which is formed on an inner circumferential surface of a first end of the first cylindrical portion, which faces an inside of the main chamber and which has therein a first communication hole, a first valve plate, which is formed between two ends of the first cylindrical portion and which has therein a first valve hole, a first push pin, which is supported at a first end thereof by the first support protrusion and extends at a second end thereof through the first valve hole, and a first spring disposed between the first support protrusion and the first push pin so as to push the first push pin toward the first valve plate, wherein the second check valve includes a second cylindrical portion fitted in a hole formed in an upper portion of the control chamber, a second support protrusion, which is formed on an inner circumferential surface of a first end of the second cylindrical portion, which faces an inside of the control chamber and which has therein a second communication hole, a second valve plate, which is formed between two ends of the second cylindrical portion and which has therein a second valve hole, a second push pin, which is supported at a first end thereof by the second support protrusion and extends at a second end thereof through the second valve hole, and a second spring disposed between the second support protrusion and the second push pin so as to push the second push pin toward the second valve plate, and wherein, when the first check valve is coupled to the second check valve, the second end of the first push pin comes into contact with the second end of the second push pin, with the result that the first push pin is moved toward the first support protrusion and the second push pin is moved toward the second support protrusion.

In accordance with another aspect of the present invention, the first support protrusion may be detachably coupled to or integrally formed with the first cylindrical portion, and the second support protrusion may be detachably coupled to or integrally formed with the second cylindrical portion.

In accordance with still another aspect of the present invention, when the first check valve is detachably coupled to the main chamber and the second check valve is detachably coupled to the control chamber, sealing members may be respectively interposed between the main chamber and the first check valve and between the control chamber and the second check valve, and sealing members may be respectively interposed between the first valve plate and the first push pin and between the second valve plate and the second push pin.

In accordance with yet another aspect of the present invention, the main chamber may include a coupler, which is formed in a wall of the main chamber and is configured to have a short pipe shape, and a socket, which is detachably coupled to or integrally formed with the coupler, and the first check valve may be detachably coupled to or integrally formed with the socket.

In accordance with still yet another aspect of the present invention, the control chamber may be in a strong vacuum state.

In accordance with a further aspect of the present invention, the control chamber may be filled with antiseptic gas under high pressure.

In accordance with another further aspect of the present invention, the control chamber may be filled with dehumidifying agent.

In accordance with still another further aspect of the present invention, the first check valve may include a filter provided at an end of the first cylindrical portion that faces the inside of the main chamber.

In accordance with yet another further aspect of the present invention, the cinerary urn may further include an extending wall, which extends from a wall of the main chamber to define a shelter space isolated from the space in the main chamber, the check valve unit and the control chamber being positioned in the shelter space.

### Advantageous Effects

The cinerary urn set according to the present invention is capable of maintaining a state in in the main chamber suitable for preventing the ashes in the main chamber from decaying or decomposing using the control chamber, and when the state in the main chamber is changed to an unsuitable state, of restoring the changed state to the suitable state by allowing the main chamber to communicate with the control chamber.

Since the check valve unit is composed of the first check valve and the second check vale and the state in the main chamber is restored or controlled simply by replacing the control chamber, it is possible to continuously control the environment of the ashes in the main chamber with ease without an additional special device.

Since the first check valve and the second check valve are configured so as to be detachably coupled to the corresponding chambers, it is possible to easily charge contents, such as ashes, a dehumidifying agent or the like, into the chambers.

When the cinerary urn set further includes a filter, it is possible to prevent ashes, which are in powered state, from being discharged from the main chamber.

The cinerary urn set according to the present invention may also be used for the long-term storage of old books, cultural goods, seeds or the like.

### DESCRIPTION OF DRAWINGS

The above and other objects, features and other advantages of the present invention will be more clearly understood from the following detailed description taken in conjunction with the accompanying drawings, in which:

FIG. 1 is an exploded perspective view of a cinerary urn set according to the present invention;

FIG. 2 is a cross-sectional view of the cinerary urn set according to the present invention;

FIGS. 3A-3B are views explaining the operation of the cinerary urn set according to the present invention;

FIG. 4 is a view explaining another embodiment of the cinerary urn set according to the present invention;

FIG. 5 is a view explaining a conventional cinerary urn assembly;

FIG. 6 is a view explaining a conventional cinerary urn capable of preventing the generation of moisture and unpleasant odor; and

FIG. 7 is a view explaining a conventional cinerary box.

### BEST MODE

Hereinafter, preferred embodiments of the present invention will be described. All terms including technical and scientific terms used in this specification and the claims should not be interpreted as being limited to terms such as those defined in commonly used dictionaries and should be interpreted as having meanings consistent with their meaning in the technical context of the present disclosure.

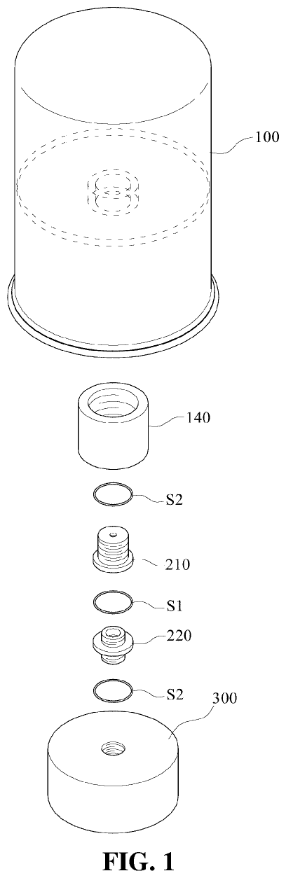

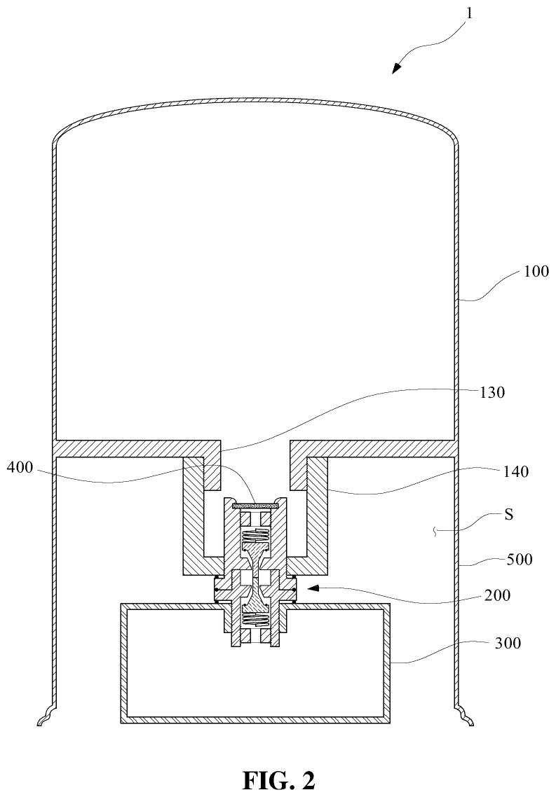

FIG. 1 is an exploded perspective view of a cinerary urn set 1 according to the present invention. FIG. 2 is a cross-sectional view of the cinerary urn set 1.

The cinerary urn set 1 according to the present invention is mainly composed of a main chamber 100, a check valve unit 200 and a control chamber 300.

The main chamber 100 is configured to have a cylindrical shape, a hexahedral shape or the like overall and to have a space in which ashes are stored. The main chamber 100 is made of an airtight material such as glass, metal and plastic.

The check valve unit 200 is coupled to the main chamber 100 so as to open and close the space in the main chamber 100.

The control chamber 300 is connected to the check valve unit 200 so as to selectively communicate with the main chamber 100 via the check valve unit 200. Specifically, the main chamber 100 does not communicate with the control chamber 300 when the check valve unit 200 closes the space in the main chamber 100 but the main chamber 100 communicates with the control chamber 300 when the check valve unit 200 opens the space in the main chamber 100. Since the space in the control chamber 300 is under a specific state or is filled with a specific material, it is possible to control the state in the main chamber 100 when the main chamber 100 communicates with the control chamber 300.

For example, the control chamber 300 may be in the strongly vacuumized state. When the control chamber 300, which is in the strongly vacuumized state, communicates with the main chamber 100, the moisture, gas or the like in the main chamber 100 moves into the control chamber 300 in order to establish equilibrium in the strength of the vacuum between the main chamber 100 and the control chamber 300.

The control chamber 300 may be filled with a dehumidifying agent. The dehumidifying agent is composed of calcium carbonate, silica gel or the like, and serves to remove the moisture in the air. When the control chamber 300, which is filled with the dehumidifying agent, communicates with the main chamber 100, the moisture in the main chamber 100 is removed, thereby preventing the ashes in the main chamber 100 from decaying or decomposing.

The cinerary urn set 1 according to the present invention is able to create a state suitable for storing the ashes in the main chamber 100 for a long time using the control chamber 300 and to control the communication between the main chamber 100 and the control chamber 300 using the check valve unit 200. Consequently, it is possible to allow the main chamber 100 to communicate with the control chamber 300 when there is a need to provide a state suitable for storing the ashes in the main chamber 100.

More specifically, the check valve unit 200 is composed of a first check valve 210 and a second check valve 220.

The first check valve 210 is connected to the main chamber 110 so as to control the opening and closing of the main chamber 100, and the second check valve 220 is connected to the control chamber 300 so as to control the opening and closing of the control chamber 300. The first check valve 210 and the second check valve 220 are configured so as to be detachably coupled to each other. When the first check valve 210 and the second check valve 220 are coupled to each other, both the first check valve 210 and the second check valve 220 open.

In other words, by enabling the first check valve 210 to be detachably coupled to the second check valve 220, it is possible to allow the main chamber 100, connected to the first check valve 210, and the control chamber 300, connected to the second check valve 220, to be coupled to each other or to be separated from each other. Consequently, it is possible to replace the control chamber 300 when necessary. For example, immediately after ashes are put into the main chamber 100, the control chamber 300, which is in the strongly vacuumized state, is coupled to the main chamber 100 so as to remove moisture in the ashes or the main chamber 100. After the control chamber 300 is detached from the main chamber 100, another control chamber 300, which is filled with antiseptic gas under high pressure, is coupled to the main chamber 100 so as to inject the antiseptic gas into the main chamber 100. After the control chamber 300 is detached from the main chamber 100, another control chamber 300, which is filled with a dehumidifying agent, is coupled to the main chamber 100 so as to continuously prevent dew condensation in the main chamber 100 due to variation in external temperature for a long period of time.

Since the first check valve 210 and the second check valve 220 open when they are coupled to each other and close when they are detached from each other, it is possible to prevent foreign substances from entering the main chamber 100 or to prevent the antiseptic gas or the like in the control chamber 300 from leaking to the outside while the control chamber 300 is replaced with another one.

According to the present invention, since the state in the main chamber 100 is changed to a desired state by simply replacing the control chamber 300, it is possible to continuously and easily control environment of the ashes in the main chamber 100 without a special device.

In the case in which the check valve unit 200 is composed of the first check valve 210 and the second check valve 220, a sealing member 51, which is made of rubber, silicone or the like, is interposed between the first check valve 210 and the second check valve 220 so as to improve the airtightness between the first check valve 210 and the second check valve 220.

More specifically, the first check valve 210 is composed of a first cylindrical portion 211, a first support protrusion 212, a first valve plate 213, a first push pin 214 and a first spring 215.

The first cylindrical portion 211 is configured to have a cylindrical shape, and is coupled to the main chamber 100. The first support protrusion 212 is formed on the inner circumferential surface of the end of the first cylindrical portion 211 that faces the inside of the main chamber 100. The first valve plate 213 is formed between the two ends of the first cylindrical portion 211. The first support protrusion 212 is provided in the center thereof with a first communication hole 212a formed therethrough. The first valve plate 213 is provided in the center thereof with a first valve hole 213a, which is narrowed moving toward the outside of the main chamber 100. The first push pin 214 is supported at one end thereof by the first support protrusion 212 via the first spring 215 and projects at the other end thereof beyond the first valve plate 213 through the first valve hole 213a. The intermediate portion of the first push pin 214 is configured such that the diameter thereof decreases toward the outside of the main chamber 100 so as to enable the intermediate portion to be closely engaged with the first valve hole 213a. The first spring 215 is disposed between the first support protrusion 212 and the first push pin 214 so as to push the first push pin 214 toward the first valve plate 213 in the state of being supported by the first support protrusion 212. Accordingly, when no force is applied to the first push pin 214, the first spring 215 brings the first push pin 214 into close contact with the first valve plate 213, thereby maintaining the state in which the first valve hole 213a is closed by the first push pin 214. Meanwhile, when a force equal to or higher than the elastic force of the first spring 215 is applied to the other end of the first push pin 214, the first push pin 214 is moved toward the first support protrusion 212, thereby opening the first valve hole 213a.

The second check valve 220 is composed of a second cylindrical portion 221, a second support protrusion 222, a second valve plate 223, a second push pin 224 and a second spring 225.

The second cylindrical portion 221 is configured to have a cylindrical shape, and is disposed through the wall of the control chamber 300. The second support protrusion 222 is formed on the inner circumferential surface of the end of the second cylindrical portion 221, which faces the inside of the control chamber 300. The second valve plate 223 is formed between the two ends of the second cylindrical portion 221. The second support protrusion 222 is provided in the center thereof with a second communication hole 222a formed therethrough. The second valve plate 223 is provided in the center thereof with a second valve hole 223a, which is narrowed toward the outside of the control chamber 300. The second push pin 224 is supported at one end thereof by the second support protrusion 222 via the second spring 225, and projects at the other end thereof beyond the second valve plate 223 through the second valve hole 223a. The intermediate portion of the second push pin 224 is configured such that the diameter thereof decreases toward the outside of the control chamber 300 so as to enable the intermediate portion to be in close contact with the second valve hole 223a. The second spring 225 is disposed between the second support protrusion 222 and the second push pin 224 so as to push the second push pin 224 toward the second valve plate 223 in the state of being supported by the second support protrusion 222. Accordingly, when no force is applied to the second push pin 224, the second spring 225 brings the second push pin 224 into close contact with the second valve plate 223, thereby maintaining the state in which the second valve hole 223a is closed by the second push pin 224. Meanwhile, when a force equal to or higher than the elastic force of the second spring 225 is applied to the other end of the second push pin 224, the second push pin 224 is moved toward the second support protrusion 222, thereby opening the second valve hole 223a.

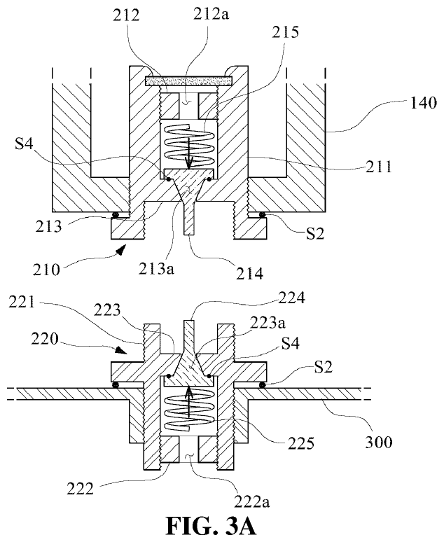

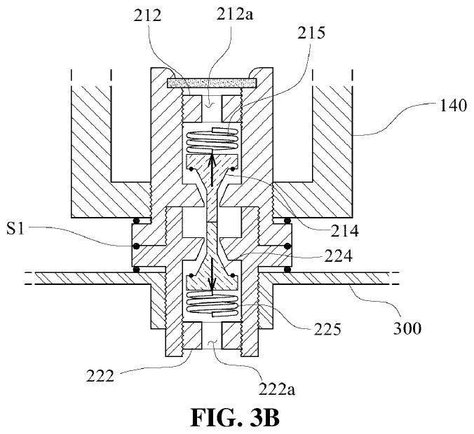

The first check valve 210 and the second check valve 220 are operated as illustrated in FIGS. 3A-3B. Specifically, when the first check valve 210 and the second check valve 220 are not coupled to each other as illustrated in FIG. 3A, both the first check valve 210 and the second check valve 220 are maintained in the closed state. When the first check valve 210 and the second check valve 220 are coupled to each other as illustrated in FIG. 3B, the other end of the first push pin 214 and the other end of the second push pin 224 come into contact with each other and push each other, with the result that the first push pin 214 is moved toward the first support protrusion 212 and the second push pin 224 is moved toward the second support protrusion 222. Accordingly, when the first check valve 210 and the second check valve 220 are coupled to each other, the main chamber 100 communicates with the control chamber 300.

The first check valve 210 and the second check valve 220 may be threadedly coupled to each other. Specifically, one of the first cylindrical portion 211 of the first check valve 210 and the second cylindrical portion 221 of the second check valve 220 may be provided on the inner circumferential surface thereof with a thread and the other of the first cylindrical portion 211 of the first check valve 210 and the second cylindrical portion 221 of the second check valve 220 may be provided on the outer circumferential surface thereof with a corresponding thread. Consequently, by virtue of the threaded engagement between the two threads, it is possible to couple the first check valve 210 to the second check valve 220. The first check valve 210 and the second check valve 220, which are threadedly coupled to each other, provide excellent coupling force and airtightness. Furthermore, since the first check valve 210 and the second check valve 220 are easily coupled to and separated from each other, it is possible to easily replace the control chamber 300 even by those not skilled in the art.

The first check valve 210 may be detachably coupled to the main chamber 100, and the second check valve 220 may also be detachably coupled to the control chamber 300.

According to the present invention, it is possible to put ashes into the main chamber 100 in the state in which the first check valve 210 is separated from the main chamber 100 and to put a dehumidifying agent into the control chamber 300 in the state in which the second check valve 220 is separated from the control chamber 300. Furthermore, when the capability of the dehumidifying agent in the control chamber 300 to remove moisture is deteriorated because the control chamber 300, which is filled with the dehumidifying agent, has been maintained in the state of being coupled to the main chamber 100 for a long period of time, the second check valve 220 is separated from the control chamber 300 in order to remove the existing dehumidifying agent and put a new dehumidifying agent into the control chamber 300, and the second check valve 220 is then coupled to the control chamber 300 again. Accordingly, it is possible to continuously maintain a state suitable for the inside of the main chamber 100 simply by replacing the dehumidifying agent in the control chamber 300.

In the case in which the first check valve 210 is detachably coupled to the main chamber and the second check valve 220 is detachably coupled to the control chamber 300, it is possible to improve the airtightness of each of the chambers by interposing a sealing member S2 between each of the check valves and a corresponding one of the chambers.

The first check valve 210 may be detachably coupled to the main chamber 100 in a threaded manner, and the second check valve 220 may also be detachably coupled to the control chamber 300 in a threadable manner.

Alternatively, the first check valve 210 may be integrally formed with the main chamber 100, and the second check valve 220 may be integrally formed with the control chamber 300. In this case, it is possible to more simply manufacture the cinerary urn set according to the present invention.

Sealing members S4 may be respectively interposed between the first valve plate 213 and the first push pin 214 and between the second valve plate 223 and the second push pin 224.

The sealing members S4, which are respectively interposed between the first valve plate 213 and the first push pin 214 and between the second valve plate 223 and the second push pin 224, serve to improve the airtightness therebetween and to reliably prevent air from leaking between the valve plates 213 and 223 and the push pins 214 and 224 when the first valve plate 213 and the second valve plate 223 are respectively in close contact with the first push pin 214 and the second push pin 224.

The main chamber 100 may further include a coupler 130 and a socket 140. The first check valve 210 may be detachably coupled to or integrally formed with the socket 140 of the main chamber 100.

The coupler 130 is configured to have a short pipe shape, and is formed through the wall of the main chamber 100. Although the coupler 130 may be formed through the bottom wall of the main chamber 100 as illustrated in FIG. 2, the coupler 130 may also be formed through the top wall or side wall of the main chamber 100.

The socket 140 is detachably coupled to or integrally formed with the coupler 130.

In the case in which the socket 140 is detachably coupled to the coupler 130, it is possible to easily perform an operation of filling the main chamber 100 with ashes. In the case in which the socket 140 is integrally formed with the coupler 130, it is possible to simplify the construction of the main chamber 100. The socket 130 may be detachably coupled to the coupler 130 in a threadable manner.

In the case in which the socket 140 is detachably coupled to the coupler 130, it is preferable that a sealing member be interposed between the socket 140 and the coupler 130.

The first support protrusion 212 may be detachably coupled to or integrally formed with the first cylindrical portion 211, and the second support protrusion 222 may be detachably coupled to or integrally formed with the second cylindrical portion 221.

In the case in which the first support protrusion 212 is detachably coupled to the first cylindrical portion 211, it is possible to easily dispose the first spring 215 between the first support protrusion 212 and the first push pin 214. In the case in which the second support protrusion 222 is detachably coupled to the second cylindrical portion 221, it is also possible to easily dispose the second spring 225 between the second support protrusion 222 and the second push pin 224. Each of the first and second support protrusions 212 and 222 may be detachably coupled to a corresponding one of the first and second cylindrical portions 211 and 222 in a threadable manner.

In the case in which the first support protrusion 212 is integrally formed with the first cylindrical portion 211 and the second support protrusion 222 is integrally formed with the second cylindrical portion 221, it is possible to simplify the construction of the first check valve 210 and the second check valve 220.

The cinerary urn set 1 according to the present invention may further include a filter 400.

The filter 400 is disposed at the end of the first cylindrical portion 211 that faces the inside of the main chamber 100 so as to prevent powdered ashes other than moisture from being discharged from the main chamber 100 when the control chamber 30, which is in the strongly vacuumized state, communicates with the main chamber 100.

The cinerary urn set 1 according to the present invention may further include an extending wall 500.

The extending wall 500 extends from the wall of the main chamber 100, and defines a shelter space S, which is isolated from the space in the main chamber 100. When the check valve unit 200 and the control chamber 300 are positioned in the shelter space S, it is possible to prevent the appearance of the cinerary urn set 1 from being marred by the control chamber 300 and related components.

As illustrated in FIG. 2, the shelter space S is open at one side thereof so as to allow a worker to easily access the control chamber 300 or the like in the shelter space S.

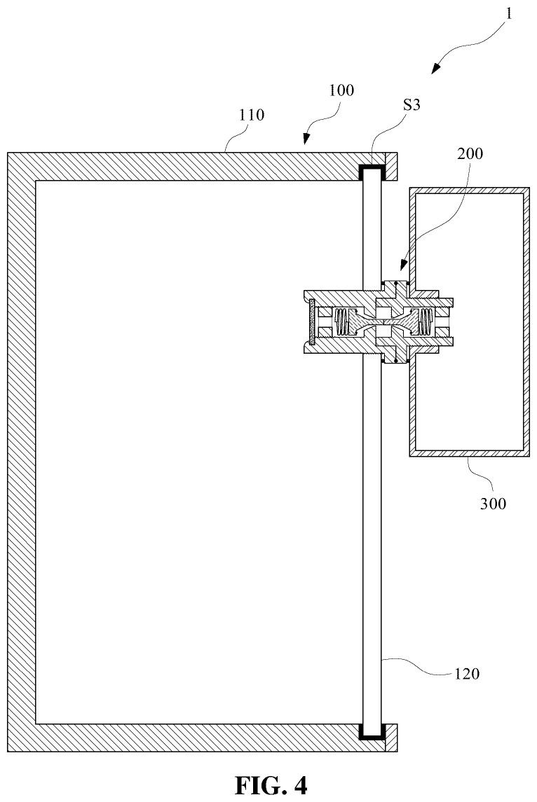

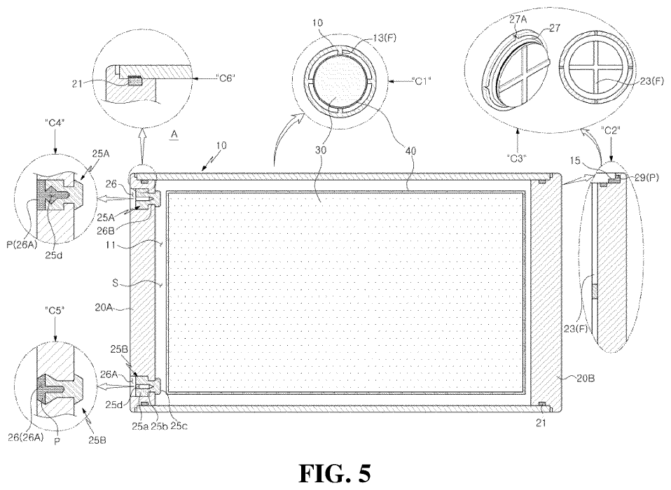

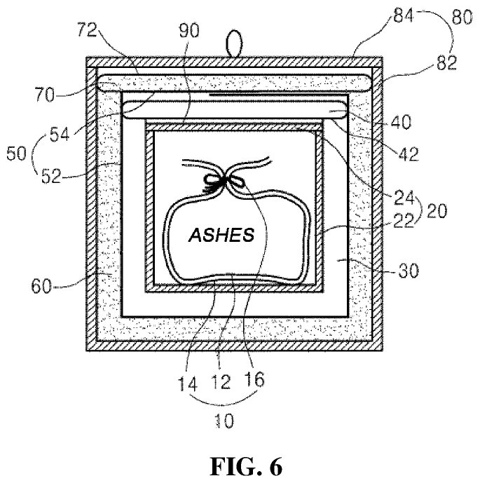

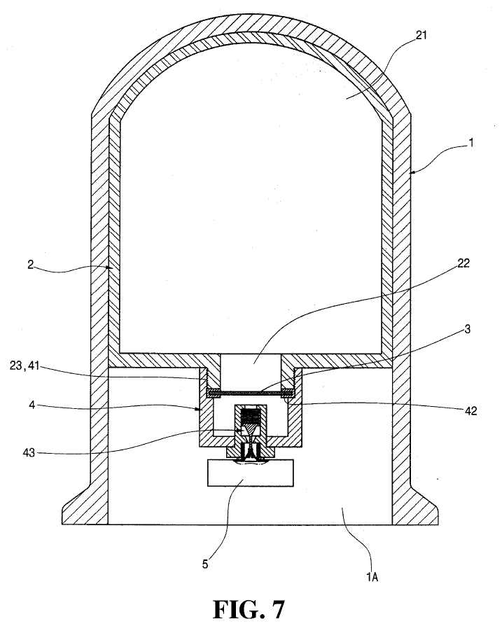

As illustrated in FIG. 4, the main chamber 100 of the cinerary urn set 1 according to the present invention may be composed of a body 110 and a cover 120. When the main chamber 100 is provided with the cover 120, the cover 120 is made of a transparent material or an opaque material. In the case in which the cover 120 is made of a transparent material, it is possible to allow the contents of the main chamber 100 to be viewed from the outside. The cover 120 is made of glass, plastic, stone, metal or the like.

In the case in which the main chamber 100 is composed of the body 110 and the cover 120, a sealing member S3 is interposed between the body 110 and the cover 120 so as to ensure the airtightness of the main chamber 100.

As described above, the cinerary urn set 1 according to the present invention may be used in a charnel house for storing a plurality of persons' cremated bones. In addition, the cinerary urn set 1 according to the present invention may also be used in a space in which humidity or the like needs to be controlled for the long-term storage of old books, cultural goods, seeds or the like.

1. A cinerary urn set comprising:
a main chamber having a space for storing ashes therein;
a check valve unit including a first check valve, which is detachably coupled to or integrally formed with the main chamber, and a second check valve, which is detachably coupled to the first check valve and which is configured to communicate with the first check valve when the second check valve is coupled to the first check valve; and
a control chamber, which is detachably coupled to or integrally formed with the second check valve and which is configured to communicate with the main chamber when the control chamber is coupled to the second check valve,
wherein the first check valve includes a first cylindrical portion coupled to the main chamber, a first support protrusion, which is formed on an inner circumferential surface of a first end of the first cylindrical portion, which faces an inside of the main chamber and which has therein a first communication hole, a first valve plate, which is formed between two ends of the first cylindrical portion and which has therein a first valve hole, a first push pin, which is supported at a first end thereof by the first support protrusion and extends at a second end thereof through the first valve hole, and a first spring disposed between the first support protrusion and the first push pin so as to push the first push pin toward the first valve plate,
wherein the second check valve includes a second cylindrical portion fitted in a hole formed in an upper portion of the control chamber, a second support protrusion, which is formed on an inner circumferential surface of a first end of the second cylindrical portion, which faces an inside of the control chamber and which has therein a second communication hole, a second valve plate, which is formed between two ends of the second cylindrical portion and which has therein a second valve hole, a second push pin, which is supported at a first end thereof by the second support protrusion and extends at a second end thereof through the second valve hole, and a second spring disposed between the second support protrusion and the second push pin so as to push the second push pin toward the second valve plate, and
wherein, when the first check valve is coupled to the second check valve, the second end of the first push pin comes into contact with the second end of the second push pin, with the result that the first push pin is moved toward the first support protrusion and the second push pin is moved toward the second support protrusion.

2. The cinerary urn set according to claim 1, wherein the first support protrusion is detachably coupled to or integrally formed with the first cylindrical portion, and the second support protrusion is detachably coupled to or integrally formed with the second cylindrical portion.

3. The cinerary urn set according to claim 1, wherein, when the first check valve is detachably coupled to the main chamber and the second check valve is detachably coupled to the control chamber, sealing members are respectively interposed between the main chamber and the first check valve and between the control chamber and the second check valve, and sealing members are respectively interposed between the first valve plate and the first push pin and between the second valve plate and the second push pin.

4. The cinerary urn set according to claim 1, wherein the main chamber includes a coupler, which is formed in a wall of the main chamber and is configured to have a short pipe shape, and a socket, which is detachably coupled to or integrally formed with the coupler, and the first check valve is detachably coupled to or integrally formed with the socket.

5. The cinerary urn set according to claim 1, wherein the control chamber is in a vacuum stage.

6. The cinerary urn set according to claim 1, wherein the control chamber is filled with antiseptic gas under high pressure.

7. The cinerary urn set according to claim 1, wherein the control chamber is filled with a dehumidifying agent.

8. The cinerary urn set according to claim 1, wherein the first check valve includes a filter provided at an end of the first cylindrical portion that faces the inside of the main chamber.

9. The cinerary urn set according to claim 1, further comprising an extending wall, which extends from a wall of the main chamber to define a shelter space isolated from the space in the main chamber, the check valve unit and the control chamber being positioned in the shelter space.
